(19) United States
(12) Patent Application Publication
(10) Pub. No.: US 2006/0276220 A1
(43) Pub. Date: Dec. 7, 2006

(54) Cell phone case with magnifier and method

(76) Inventor: Judith Schure, Ambler, PA (US)

Correspondence Address: BLANK ROME LLP, 600 NEW HAMPSHIRE AVENUE, N.W., WASHINGTON, DC, 20037, US

(21) Appl. No.: 11/445,141

(22) Filed: Jun. 2, 2006

Related U.S. Application Data
(60) Provisional application No. 60/686,978, filed on Jun. 3, 2005.

(51) Int. Cl. H04M 1/00

(52) U.S. Cl. 455/550.1

(57) ABSTRACT

A case for a cell phone that includes first and second opposite portions defining a receiving area therebetween adapted to receive at least a portion of a cell phone. A first magnifying member is disposed in one of the first and second portions. The first magnifying member is alignable with at least one display screen of the cell phone, whereby the first magnifying member is adapted to magnify images on the display screen.

### RELATED APPLICATION

This application claims the benefit under 35 U.S.C. 119 of U.S. Provisional Application Ser. No. 60/686,978, filed on Jun. 3, 2005, the subject matter of which is incorporated by reference.

### FIELD OF THE INVENTION

The present invention generally relates to a case for a cell phone. More specifically, the case includes a magnifying member for magnifying images of the cell phone display screen.

### BACKGROUND OF THE INVENTION

Conventional flip-type cell phones include a main key pad portion and a hinged flip cover portion. The flip cover portion typically includes a display screen on the outside of the flip portion which can be viewed even when the flip portion is closed on the key pad portion of the phone. The flip portion also includes a main display screen on the inside of the flip cover portion that is visible when the flip cover portion is flipped open. Often people who use cell phones need assistance reading the small type on either or both of the display screens of the phone.

### SUMMARY OF THE INVENTION

Accordingly, the present invention provides a case for a cell phone that includes first and second opposite portions defining a receiving area therebetween adapted to receive at least a portion of a cell phone. A first magnifying member is disposed in one of the first and second portions. The first magnifying member is alignable with at least one display screen of the cell phone, whereby the first magnifying member is adapted to magnify images on the display screen.

The present invention also provides a case for a cell phone including first and second opposite portions, and a receiving area between said first and second portions that receives at least a portion of the cell phone. The first portion has a first magnifying member aligned with a first display screen of the cell phone. The second portion has a second magnifying member aligned with a second display screen of the cell phone, whereby the first and second magnifying members magnify images on the first and second display screens of the cell phone.

The present invention also provides a method of providing magnification of a cell phone comprising the steps of providing a cell phone having at least one display screen for displaying images; and magnifying the images on the display screen of the cell phone by covering the display screen with a magnifying member, the magnifying member being disposed in a case configured to receive at least a portion of the cell phone.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a side elevational view of a case according to an embodiment of the present invention, showing a magnifying lens disposed in a portion of the case covering a cell phone, thereby magnifying the text and images of a display screen of the phone;

FIG. 2 is a side elevational view of the case of the present invention, showing another magnifying lens disposed in an opposite portion of the case, thereby magnifying the text and images of another display screen of the cell phone; and

FIG. 3 is a partial sectional view of the case of the present invention, showing at least a portion of the cell phone received in the case.

### DETAILED DESCRIPTION OF THE INVENTION

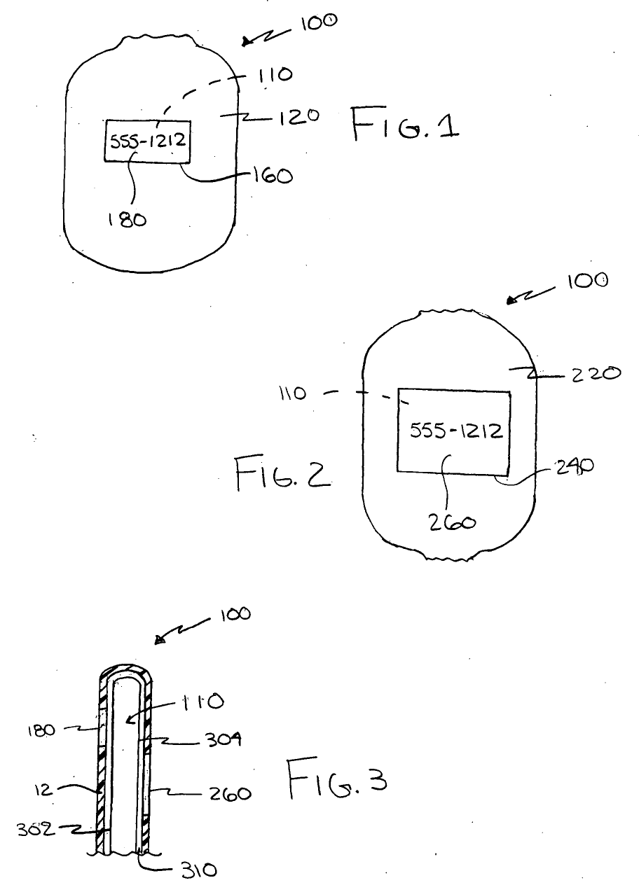

Referring to FIGS. 1-3, the case 100, in accordance with the present invention, includes a first portion 120 (FIG. 1) covering one side 302 of a cell phone 110 and a second portion 220 (FIG. 2) covering the opposite side 304 of the cell phone 110. The case 100 is preferably made of leather or vinyl but can be made of any flexible material.

Embedded within the first portion 120 of the case 100 is a first magnifying member, such as lens 160 that aligns with a first display screen 180 of the cell phone to magnify any text, images, and/or graphics on the screen 180. Similarly, embedded within the second portion 220 of the case 100 is a second magnifying member, such as lens 240 that aligns with another display screen 260 of the cell phone 110 to magnify any text, images, and/or graphics on the screen 260.

The first and second portions 120 and 220 define a receiving area 310 therebetween that receives at least the portion of the cell phone 110 that includes the display screens 180 and 260. The receiving area 310 receives and covers the cell phone 110 such that the lenses 160 and 240 align with the cell phone display screens 180 and 260, respectively. That allows the user to clearly see both display screens 180 and 260 when operating the cell phone. The first portion 120 may cover the outside of the cell phone 110 and the second portion 220 may cover the inside of the cell phone where the second display screen 260 is a main screen and the first display screen 180 a smaller secondary screen. The case 100 may include additional portions to cover the entire cell phone, such as the key pad portion of the phone.

Each of the first and second magnifying lenses 160 and 240 are preferably formed of a flexible magnifying material. However, lenses 160 and 240 can be formed of any magnifying material, including a rigid material. Also, each magnifying lens 160 and 240 is sized commensurate with display screens 180 and 260, respectively. However, lenses 160 and 240 can be made smaller or larger than display screens 180 and 260. As seen in FIGS. 1 and 2, the lenses 160 and 240 may be formed integrally with the first and second portions 120 and 220 of the case 100.

Although the case 100 is preferably used with a flip type cell phone, the case 100 can be used with any type of cell phone, such as a non-flip type cell phone, as long as a magnifying member covers the display screen of the cell phone.

While a particular embodiment has been chosen to illustrate the invention, it will be understood by those skilled in the art that various changes and modification can be made therein without departing from the scope of the invention as defined in the appended claims.

What is claimed is:

1. A case for a cell phone, comprising:
first and second opposite portions defining a receiving area therebetween adapted to receive at least a portion of a cell phone; and
a first magnifying member disposed in one of said first and second portions, said first magnifying member being alignable with at least one display screen of the cell phone, whereby the first magnifying member is adapted to magnify images on the display screen.

2. A case according to claim 1, wherein
a second magnifying member is disposed in the other of said first and second portions, said second magnifying member being alignable with a second display screen of the cell phone to magnifying images on the second display screens.

3. A case according to claim 2, wherein
the display screens of the cell phone on are located on inside and outside portions, respectively, of the cell phone.

4. A case according to claim 2, wherein
said first and second magnifying lenses are flexible lenses.

5. A case according to claim 1, wherein
said first and second portions are formed of a flexible material.

6. A case for a cell phone, comprising:
first and second opposite portions, and a receiving area between said first and second portions that receives at least a portion of the cell phone,
said first portion having a first magnifying member aligned with a first display screen of the cell phone, and
said second portion having a second magnifying member aligned with a second display screen of the cell phone,
whereby said first and second magnifying members magnify images on the first and second display screens of the cell phone.

7. A case according to claim 6, wherein
each of said first and second portions and each of said first and second magnifying members are made of a flexible material.

8. A case according to claim 6, wherein
said first and second magnifying members are located on an opposite sides of the cell phone.

9. A case according to claim 6, wherein
said first magnifying member is integral with the first portion; and
said second magnifying member is integral with the second portion.

10. A case according to claim 6, wherein
said first and second magnifying members are first and second flexible magnifying lenses.

11. A method of providing magnification of a cell phone comprising the steps of:
providing a cell phone having at least one display screen for displaying images; and
magnifying the images on the display screen of the cell phone by covering the display screen with a magnifying member, the magnifying member being disposed in a case configured to receive at least a portion of the cell phone.

12. A method according to claim 11, further comprising the steps of
magnifying images of a second display screen of the cell phone by covering the second display with a second magnifying member, the second magnifying member being disposed in the case.

13. A method according to claim 12, wherein
each of the magnifying members is a flexible magnifying lens.
